(19) United States
(12) Patent Application Publication
(10) Pub. No.: US 2007/0127078 A1
(43) Pub. Date: Jun. 7, 2007

(54) Jensenboard

(75) Inventor: James Lucas Jensen, Dixon, CA (US)

Correspondence Address: James Lucas Jensen, 750 Stratford Avenue, Dixon, CA, 95620, US

(73) Assignee: Mr. James Lucas Jensen, Dixon, CA (US)

(21) Appl. No.: 11/164,701

(22) Filed: Dec. 1, 2005

(51) Int. Cl. B41C 1/04

(52) U.S. Cl. 358/3.32; 358/3.29

(57) ABSTRACT

The Jensenboard allows the user to simulate writing on a document without leaving permanent markings and is easily operated by a single person.

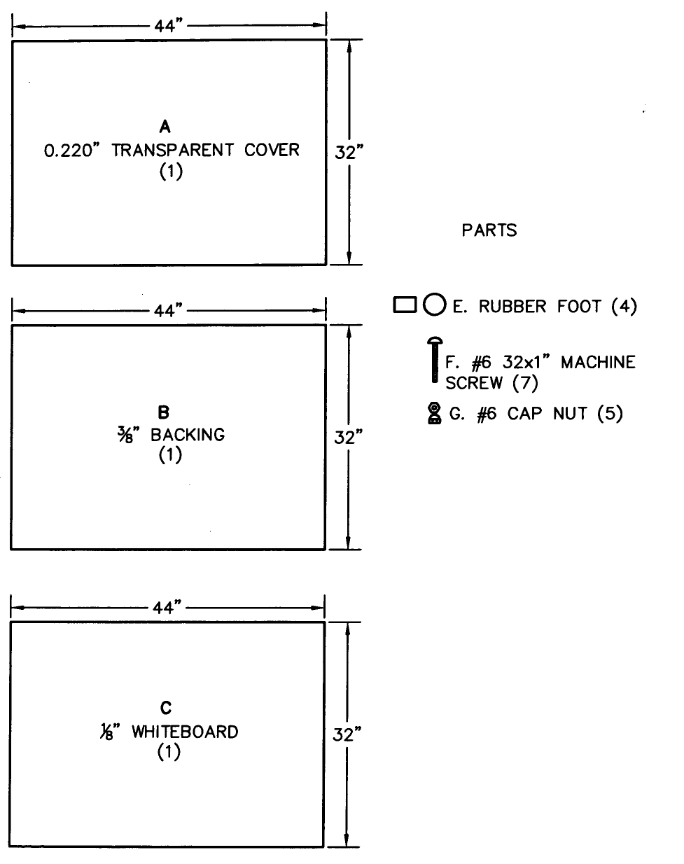

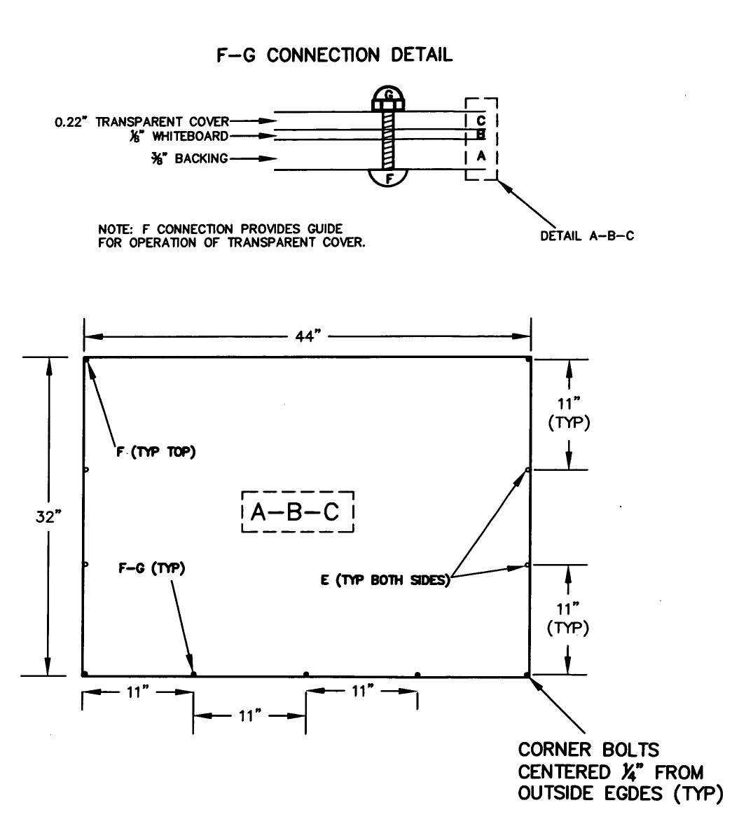

What the Jensenboard Does

The Jensenboard allows its user(s) to draw on plans, large photographs, or any other document, without leaving permanent markings. It can be utilized by planners, engineers, architects, developers, universities, and much more. When the Jensenboard is not serving its primary purpose, it can still act as a traditional dry erase board. Because of the wide range of users, the Jensenboard will ultimately be offered in several sizes. At this time, the size that will be offered is 32″×44″. The Jensenboard offers significant reduction in costs associated with printing, as it allowed for recycled use of one of copy of any particular document.

How the Jensenboard Works

The Jensenboard, when not being used for its primary service, appears as a white dry erase board, and can be used as such. However, its main beneficial utility is the ability to house a document, typically large, so that it can be written on, in a meeting or training scenario, without leaving permanent markings. This capability is achieved by the use of a transparent cover on the Jensenboard that can be written on, with the proper writing utensil, and cleaned after use. The transparent cover is secured to the white backing and designed for single-person operation to conveniently insert a large document into position for use. FIG. A, Parts Catalog, shows the materials used to create a Jensenboard. FIG. B, Assembly Instructions, details the order in which the materials are combined to create the Jensenboard, including a detail of the anchoring of the transparent cover.

What is claimed is:

1. The use of a transparent material, which may contain acrylics or other plastics, secured to a backing of any color to protect a document for the purpose of writing on the document without leaving permanent markings. This claim excludes “Sheet Protectors” or sizes 11″×17″ and smaller.

2. The name “Jensenboard”

3. How the Jensenboard functions. With the bottom of the transparent cover secured to the backing, per the attached assembly instructions, the Jensenboard can be operated by pulling the top of the cover away from the backing, loading the document, and releasing the cover. The flex in the transparent cover will restore the cover to its closed position upon release, and the static electricity on the surface of the transparent cover will hold the document in place.
